(19) United States
(12) Patent Application Publication
(10) Pub. No.: US 2020/0408513 A1
(43) Pub. Date: Dec. 31, 2020

(54) PORTABLE TARGETING SYSTEM FOR 3D SCANNERS

(71) Applicant: The Boeing Company, Chicago, IL (US)

(72) Inventors: Justin M. T. Emmons, Godfrey, IL (US); Donald J. Irvin, Waterloo, IL (US)

(73) Assignee: The Boeing Company, Chicago, IL (US)

(21) Appl. No.: 16/455,262

(22) Filed: Jun. 27, 2019

(51) Int. Cl. G01B 11/25; G06T 17/00

(52) U.S. Cl. CPC G01B 11/2518; G06T 2200/04; G06T 17/00

(57) ABSTRACT

A device for providing a targeting platform for a 3D scanning system is provided. The device includes a rigid bulk structure; a measuring surface arranged on a first side of the rigid bulk structure; a mounting surface arranged on a second side opposite the first side; one or more mounting structures arranged on the mounting surface, wherein the one or more mounting structures provides for removable mounting of the device from another surface; and a plurality of targeting members on the measuring surface, wherein the measuring surface is arranged to provide supplemental metrology scans for the another surface.

### FIELD

The present disclosure relates to systems and methods for 3D scanning.

### BACKGROUND

A 3D scanning apparatus is used in a wide range of fields, such as business, construction, medicine, industry, academic research, and culture as an optical apparatus for obtaining a 3D shape and color information of an object. The 3D scanning apparatus is implemented in a variety of ways, e.g., a laser triangulation, a structured-light projection, and a time of flight (TOF), and stores obtained 3D shape information of the object in a 3D file format available on a computer system.

The 3D scanning technology acquires the shape information about the object and stores the shape information in a computer model. Demands for the 3D scanning technology keeps steadily increasing in various fields, such as robot navigation, component defect inspection, reverse engineering, a human computer interaction (HCI), and non-destructive testing.

### SUMMARY

The following presents a simplified summary in order to provide a basic understanding of some aspects of one or more implementations of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

In accordance with examples of the present disclosure, a device for providing a targeting platform for a 3D scanning system is provided. The device comprises a rigid bulk structure; a measuring surface arranged on a first side of the rigid bulk structure; a mounting surface arranged on a second side opposite the first side; one or more mounting structures arranged on the mounting surface, wherein the one or more mounting structures provides for removable mounting of the device from another surface; and a plurality of targeting members on the measuring surface, wherein the measuring surface is arranged to provide supplemental metrology scans for the another surface.

Various examples of the present disclosure can include the following features. In some examples, one or more of the rigid bulk structure, the measuring surface, the mounting surface comprises a material with a low coefficient of thermal expansion. In some examples, the material comprises carbon fiber, titanium, aluminum, or glass. In some examples, the one or more mounting structures comprise a suction-based mechanism, an adhesive-based mechanism, a magnetic-based mechanism, or combinations thereof. In some examples, the plurality of targeting members are fixed or movable on the measuring surface. In some examples, the plurality of targeting members comprise a material that is contrast-based or retro-reflector based. In some examples, the rigid bulk structure, the measuring surface, the mounting surface is composed of a similar material to the another surface. In some examples, the device further comprises a hinge to permit another device to be flexibly attached. In some examples, the plurality of targeting members are arranged in an asymmetric pattern. In some examples, the plurality of targeting members are arranged having a predetermined density based on characteristics of a 3D scanner. In some examples, the measuring surface, the mounting surface, or both comprises one or more mounting members for attaching one or more scanning aids to provide additional depth to the targeting platform. In some examples, the one or more scanning aids comprise a prism or a tooling ball. In some examples, the one or more mounting members comprise one or more holes. In some examples, the tooling ball comprises a scale bar to provide for validation of a scale of at least a portion of the measuring surface.

In accordance with examples of the present disclosure, a 3D scanning system is provided. The 3D scanning system comprises a 3D scanner; a device for providing a targeting platform for a 3D scanning system, the device comprising: a rigid bulk structure; a measuring surface arranged on a first side of the rigid bulk structure; a mounting surface arranged on a second side opposite the first side; one or more mounting structures arranged on the mounting surface, wherein the one or more mounting structures provides for removable mounting of the device from another surface; and a plurality of targeting members on the measuring surface, wherein the measuring surface is arranged to provide supplemental metrology scans for the another surface, a computer comprising at least one hardware processor configured analyze data received from the scanner.

In accordance with examples of the present disclosure, a method for 3D scanning is provided. The method comprises attaching a targeting structure to a surface to be scanned, wherein the targeting structures comprises: a measuring surface arranged on a first side of a rigid bulk structure; a mounting surface arranged on a second side opposite the first side; one or more mounting structures arranged on the mounting surface, wherein the one or more mounting structures provides for removable mounting of the device from another surface; and a plurality of targeting members on the measuring surface, wherein the measuring surface is arranged to provide supplemental metrology scans for the another surface; scanning a target area of the surface and a portion of the targeting structure with an optical scanner; detecting reflected, scattered, or both light from the target area; and analyzing the reflected, scattered, or both light from the target area to make one or more measurements of the surface.

### BRIEF DESCRIPTION OF THE FIGURES

The accompanying drawings, which are incorporated in, and constitute a part of this specification, illustrate implementations of the present teachings and, together with the description, serve to explain the principles of the disclosure.

FIG. 1 shows a device 100 for providing a targeting platform for a 3D scanning system, according to examples of the present disclosure.

FIG. 2 shows a scanning system 200 using the device 100 of FIG. 1, according to examples of the present disclosure.

FIG. 3 shows another angle of the scanning system 200 of FIG. 2.

FIG. 4 shows additional angles of the scanning system 200 of FIG. 2.

FIG. 5 shows additional angles of the scanning system 200 of FIG. 2.

FIG. 6 shows another example of the device 100 of FIG. 1.

FIG. 7 shows a front perspective view of the device 100 of FIG. 1.

FIG. 8 shows a rear perspective view of the device of FIG. 7.

FIG. 9 shows a method 900 for 3D scanning according to examples of the present disclosure.

FIG. 10 is an example of a hardware configuration for a computer device 1000, according to examples of the present disclosure.

FIG. 11 shows an example of the computer device 1000 running a software program that can process and analyze the data obtained from the 3D scanner 205.

FIG. 12 show a close-up of the data of FIG. 11 generated by the computer device 1000.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Wherever convenient, the same reference numbers will be used throughout the drawings to refer to the same or like parts.

A conventional 3D scanning technology performs the 3D scanning of a subject through image combination by photographing the subject, which is to be taken, at different exposure levels and combining the photographed images. The use of conventional 3D scanning technologies can be limited by a number of factors including, but are not limited to, size and shape of the object being scanned, the ability of a user of a 3D scanner to position the 3D scanner in an optimum location to complete the scan, and the materials from which the object is composed.

Generally speaking, aspects of the present disclosure provides for a targeting system that is portable, interchangeable, and non-destructive, and which can be used to create an area of targets for a 3D scanning system. The targeting system can provide for portability and flexibility to support metrology and non-destructive inspection (NDI) that can be easily attached to a part or assembly's awkward locations and shapes and be used to receive supplemental (or bridge points) metrology laser scans, relocated and used again. The targeting system provides for the ability to create additional reference points to allow a higher-fidelity point-cloud of metrology data to be more accurately positioned and oriented for inspection.

In examples, the system removably mounts to an area around a desired scanning region by the use of non-destructive methods. The mounting can be provided by use of suction cup(s), magnet(s), etc. Other suitable mounting mechanisms can also be used provided that they are removable and do not harm the structure being scanned. Additionally, other various sized and shaped stand offs and/or ball and socket joints can be attached to the structure to locate an artifact in space. The artifact can then be used to create a targeted area in which the 3D scanner would use to obtain data.

The present targeting system would help solve the issues of limited target space, which 3D scanners use in order to capture sufficient data of the structure being scanned to be analyzed. Current solutions involve creating an area from various objects that could be found in a lab or shop floor in which more targets could be placed. This is typically done by constructing a scanning environment. While these constructions can work, they are far more time consuming to create, and not always created in a way to optimize data collection. In addition these set up constructions are very difficult to replicate in future endeavors.

Aspects of the present disclosure provides for a portable targeting system that allows for a set of interchangeable options to be used in which one or more targets can be positioned around an area that is to be scanned. This allows for non-destructive attachment to a variety of structures, such as aircraft and other similar structures, and allows for an operator to properly locate targets in order to optimize data collection. Attachments can include, but are not limited to, suction cups and magnets. One or more interchangeable pieces can also be used, including, but are not limited to, various length stand offs and varying degree stand offs, and articulated ball and socket mounts. By combining the mounts and the interchangeable pieces, targets can be located in an optimized way, and in a repeatable, timely manner.

The present targeting system allows for 3D scanning of a structure with limited target space. The targeting system provides for the ability to create additional reference points to allow a higher-fidelity point-cloud of metrology data to be more accurately positioned and oriented for inspection. The targeting system can be used to bridge metrology regions in a part or assembly where the edges, interior, or size prohibits easy inspection. The targeting system can be used whether or not CAD data exists on the structure. The targeting system can be used on both sheet metal and composite parts or assembly. The targeting system can be used on military or commercial vehicles. The targeting system can support any stage of NDI inspection, in-process, service-life inspection, reset program, or MRO.

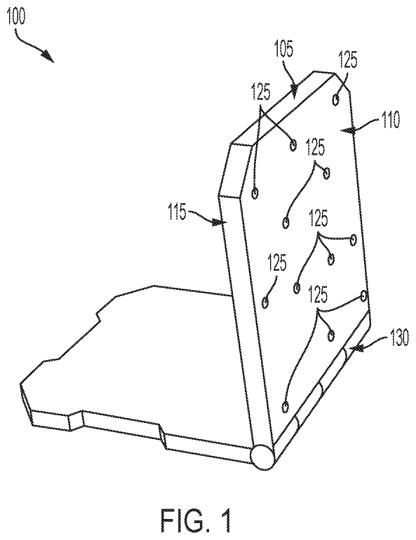

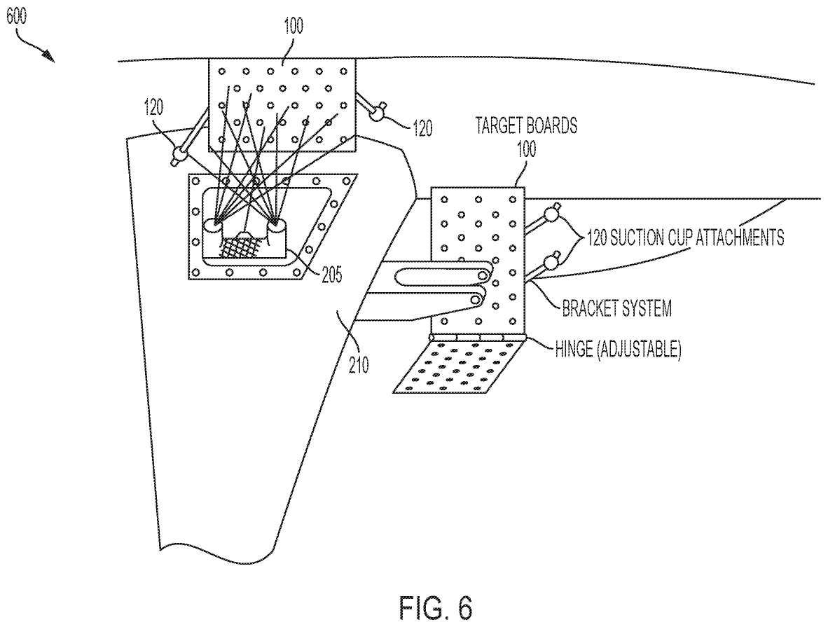

FIG. 1 shows a device 100 for providing a targeting platform for a 3D scanning system, according to examples of the present disclosure. The device 100 comprises a rigid bulk structure 105, a measuring surface 110 arranged on a first side of the rigid bulk structure, a mounting surface 115 arranged on a second side opposite the first side, one or more mounting structures 120 (shown in FIG. 6) arranged on the mounting surface, wherein the one or more mounting structures provides for removable mounting of the device from another surface, a plurality of targeting members 125 on the measuring surface 110. The measuring surface 110 is arranged to provide supplemental metrology scans for the another surface.

In some examples, the one or more of the rigid bulk structure 105, the measuring surface 110, the mounting surface 115 can comprises a material with a low coefficient of thermal expansion. For example, the material can comprises carbon fiber, titanium, aluminum, or glass. Other suitable materials can also be used.

In examples, the one or more mounting structures 120 comprise a suction-based mechanism, an adhesive-based mechanism, a magnetic-based mechanism, or combinations thereof. Other non-destructive mounting structures can also be used. The plurality of targeting members 125 can be fixed or movable on the measuring surface 110. In some examples, the plurality of targeting members 125 comprise a material that is contrast-based, reflector, or retro-reflector based targets. In some examples, the placement of one or more of the plurality of targeting members can extend beyond the measurement surface 110 to the object being scanned. In some examples, the plurality of targeting members can include an adhesive backing for attachment. In some examples, the plurality of targeting members can include an outer circumference that is colored black for contrast purposes. In some examples, the rigid bulk structure 105, the measuring surface 110, the mounting surface 115 is composed of a similar material to the another surface, for example the surface being measured and/or analyzed by the 3D scanner. In some examples, the device 100 can further optionally comprises a hinge 130 to permit another device to be flexibly attached. In some examples, the plurality of targeting members 125 are arranged in an asymmetric pattern. In some examples, the plurality of targeting members 125 are arranged having a predetermined density based on characteristics of a 3D scanner.

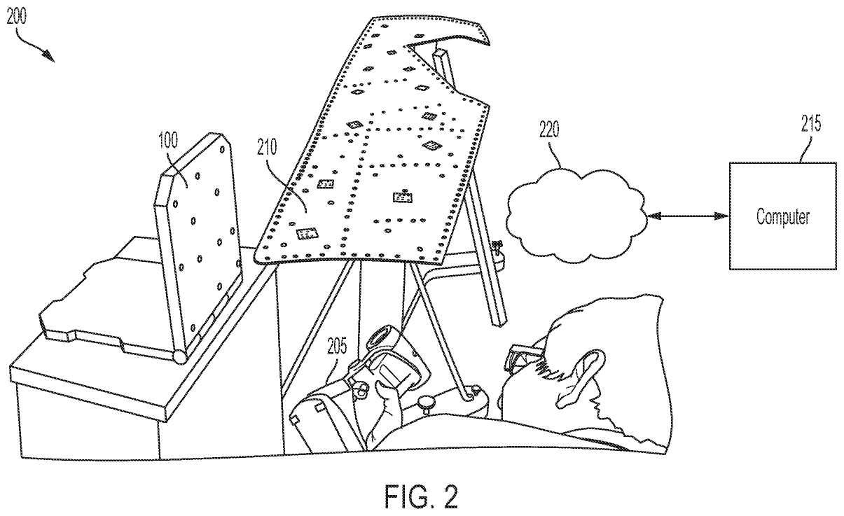

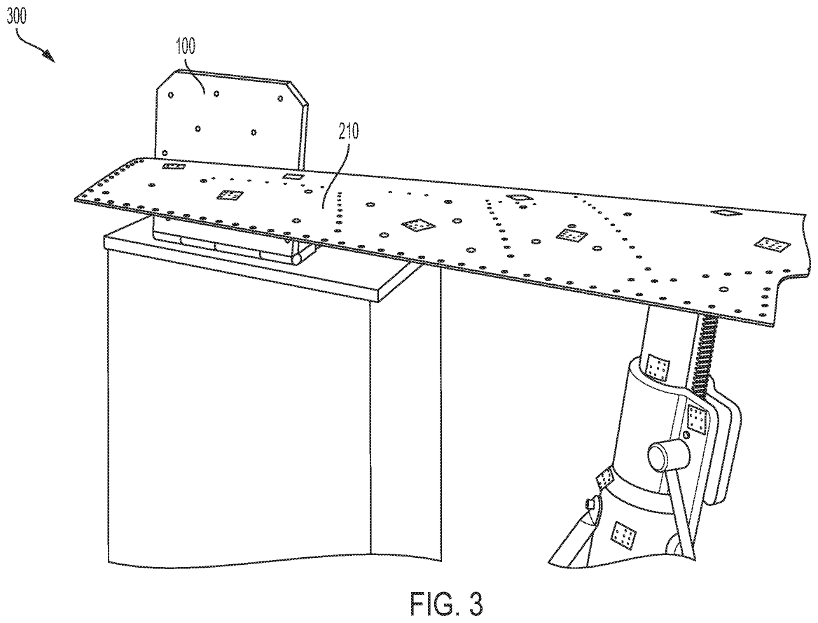

FIG. 2 shows a scanning system 200 using the device 100 of FIG. 1, according to examples of the present disclosure. The scanning system 200 comprises a 3D scanner 205, the device 100, a target 210 for scanning, a computer system 215 configured to process the results of the scanning system 200, and a communications network 220. The 3D scanner 205 can utilize a scanning technology such as, for example, structured light, photogrammetry, and laser triangulation. The 3D scanner 205 can comprise or be configured to convert or process the collected data using or in cooperation with appropriate software. The computer system 215 and the communications network 220 are discussed further with regard to FIGS. 3, 4 and 10-12.

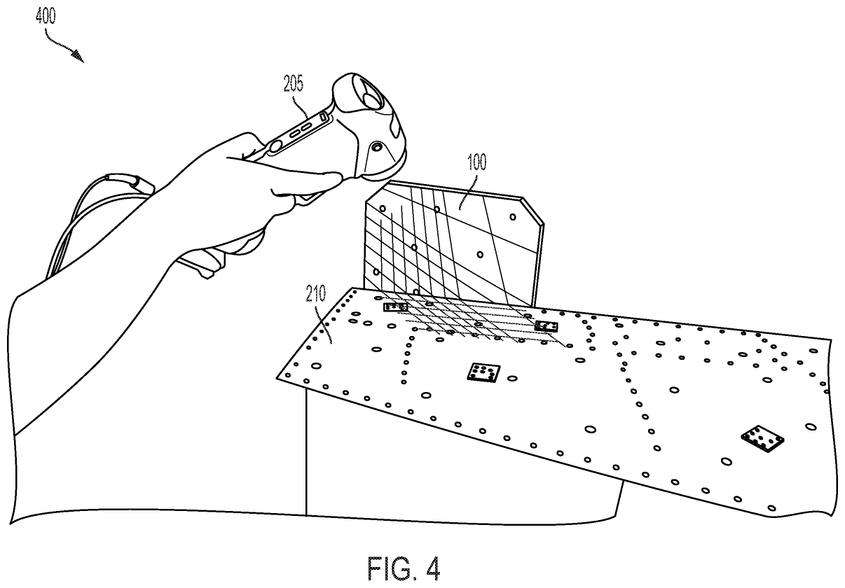

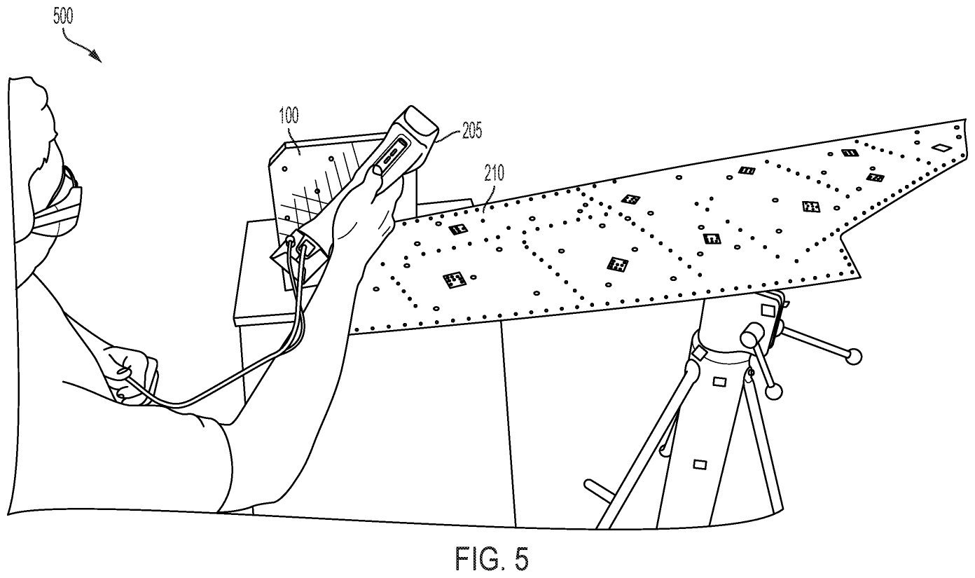

FIG. 3 shows another angle of the scanning system 200 of FIG. 2. In FIG. 3, the device 100 is shown in relation to target 210, but without showing the 3D scanner 205 or the computer system 215. FIGS. 4 and 5 show additional angles of the scanning system 200 of FIG. 2. In FIGS. 4 and 5, the 3D scanner 205 is shown during a scan of device 100 and target 210, but without showing the computer system 215.

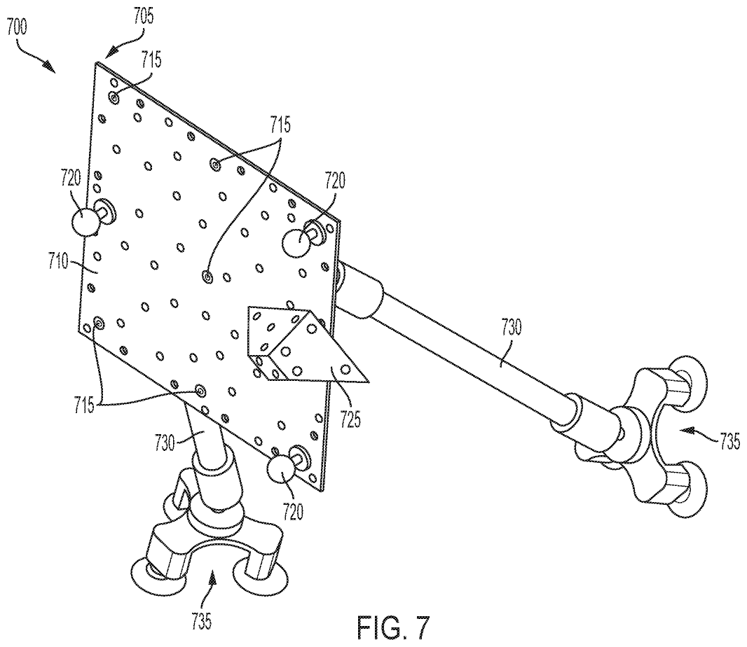

FIG. 6 shows another example of the device 100 of FIG. 1. The device 100 comprises one or mounting structures 120 that are removably attached to the target 210. In some examples, the one or more mounting members comprise one or more holes (shown in detail in FIG. 7). In some examples, the measuring surface, the mounting surface, or both comprises one or more mounting members for attaching one or more scanning aids (shown in FIG. 7) to provide additional depth to the targeting platform. In some examples, the one or more scanning aids 310 comprise a prism or a tooling ball. In some examples, the tooling ball comprises a scale bar to provide for validation of a scale of at least a portion of the measuring surface.

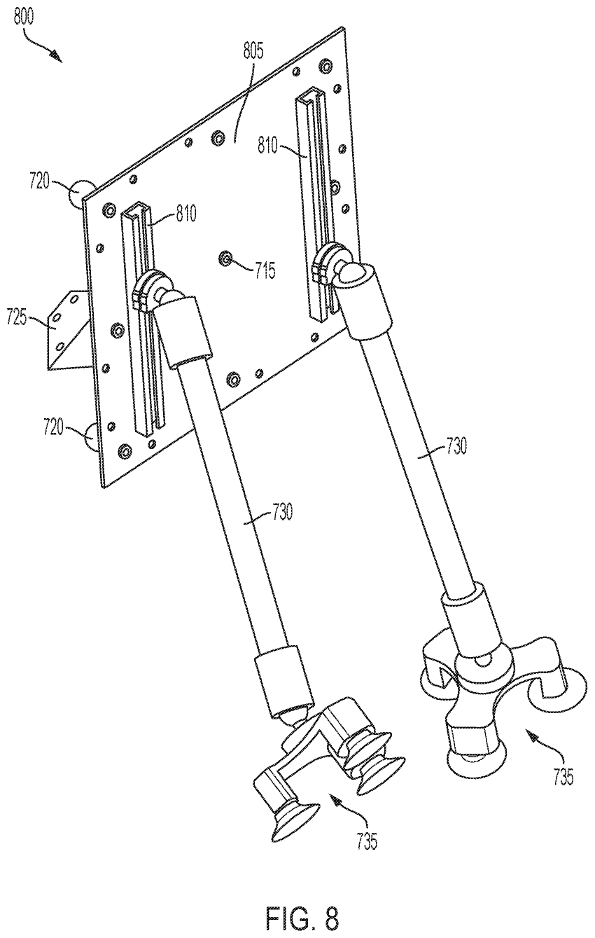

FIG. 7 shows a front perspective view 700 of the targeting device 100 of FIG. 1. FIG. 8 shows a rear perspective view 800 of FIG. 7. Targeting device 705 comprises a measurement surface 710. The measurement surface 710 comprises one or more holes 715 to allow for attachment of one or more scanning aids. The one or more scanning aids can include, but are not limited to, tooling balls 720 and/or prism 725. Mounting surface 805, which is on an opposite surface of measurement surface 710 on the targeting device, comprises one or more attachment members 810 for attaching one end of one or more mounting support members 730. The one or more mounting support members 730 terminate with one or more removably attachment members 735, which can use, but are not limited to, magnetic or suction mounting.

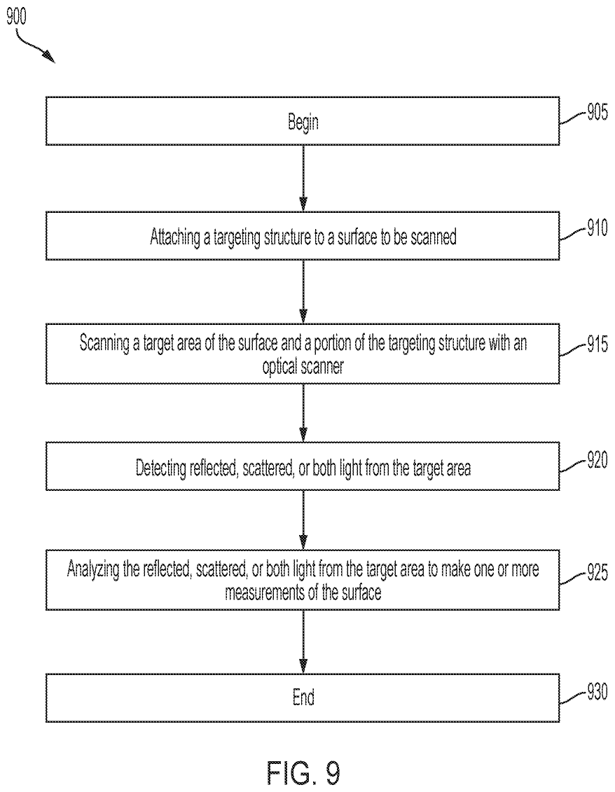

FIG. 9 shows a method 900 for 3D scanning according to examples of the present disclosure. The method 900 for 3D scanning begins at 905 and continues to 910 by attaching a targeting structure to a surface to be scanned. As discussed above, the targeting structure is the device 100 that comprises the measuring surface 110 arranged on a first side of the rigid bulk structure 195, the mounting surface 115 arranged on a second side opposite the first side, one or more mounting structures 120 arranged on the mounting surface 115. The one or more mounting structures 120 provides for removable mounting of the device from another surface. The measuring surface 110 also comprises the plurality of targeting members 125. The measuring surface 110 is arranged to provide supplemental metrology scans for the another surface. The method 900 continues at 915 by scanning a target area of the surface and a portion of the targeting structure with an optical scanner. For example, the optical scanner is the 3D scanner 205. For example, the scanning can comprise scanning an exterior surface of the surface using the 3D scanner 205 to obtain three-dimensional scanning data of the surface and the portion of the targeting structure in the form of a point cloud representative. The 3D scanner 205 can comprise a laser line scanner or multiple RGB cameras. The 3D scanner 205 can be configured to analyze a physical object to collect data on its shape, such as to collect data that can be used to construct a partial or complete digital three-dimensional model of the object. The 3D scanner 205 can be an optical 3D scanner. The 3D scanner 205 can comprise a non-contact active scanner, e.g. using light or ultrasound emissions. For example, the 3D scanner 205 can comprise a time-of-flight 3D laser scanner, a triangulation-based 3D laser scanner or a conoscopic holographic laser scanner. The 3D scanner 205 can comprise a structured light 3D scanner or a modulated light 3D scanner. The 3D scanner 205 can also comprise a non-contact passive 3D scanner, such as a stereoscopic optical imaging system, a photometric imaging system, or a silhouette imaging system. The 3D scanner 205 can include a radiation source that may emit radiation in a predetermined cone angle such as to cover, preferably, substantially the entire radiation-sensitive area of an image detector. The source may also provide a sufficiently high radiation flux such as to obtain a good signal to noise ratio during scanning. The radiation source may comprise a light source, e.g. a light source for emitting light in the infrared, near-infrared, optical and/or ultraviolet spectral range.

In some examples, the 3D scanner 205 may comprise one or more scanner sources for emitting radiation and one or more detectors for capturing reflected radiation from the surface and the portion of the targeting structure. The scanner source may comprise one or multiple radiation sources, e.g. comprising a laser and/or a light source. The 3D scanner 205 may use laser triangulation; in which the detector picks up laser light that is reflected off the surface and the portion of the targeting structure. By using trigonometric triangulation, using an accurately predetermined distance between the laser source and the detector, as well as an accurately predetermined angle between the laser and the sensor, the targeting system may calculate the distance from the point on the surface and the portion of the targeting structure to the 3D scanner 205. The 3D scanner 205 may also use a laser pulse-based technique, also known as time-of-flight scanning, based on a constant speed of light and a time period in which light from a laser source reaches the surface and the portion of the targeting structure and reflects back to the detector. The 3D scanner 205 may operate in a phase shift mode, in which the power of a laser beam is modulated, and the scanner is adapted to compare the phase of the laser light being sent out and the laser light at the detector after reflection off the surface and the portion of the targeting structure. The 3D scanner 205 may also comprise a conoscopic system, in which a laser beam is projected onto the surface and the immediate reflection along the same ray-path is transmitted through a conoscopic crystal and projected onto a detector. The 3D scanner 205 may also use a structured light scanning method that projects a series of linear patterns onto the object and detects the edge of the projected pattern with a camera, and calculate the distance similarly.

The method 900 continues at 920 by detecting reflected, scattered, or both light from the target area. For example, the 3D scanner 205 can also comprise an image detector that is configured to capture an image of the surface and the portion of the targeting structure by detecting the radiation when reflected and/or scattered by the surface and the portion of the targeting structure. The image may be obtained the image detector that is configured to capture, e.g. acquiring or detecting, parts of the image at different moments in time, e.g. acquiring the image non-simultaneously and/or in time frames corresponding to mutually disjunctive time frames of exposure. For example, the image detector may comprise a one-dimensional array of pixels, e.g. a line array, and a two-dimensional image may be collected while moving the object through the field of view of the targeting system.

In some examples, the 3D scanner 205 may produce point cloud data of the three-dimensional surface topology of the surface and the portion of the targeting structure, which may be processed, e.g. stored and processed, in the computer device 1000 described further hereinbelow, e.g. stored and processed in a machine vision device. The point cloud may consist of a number of points, e.g. coordinates identifying such points, on the surface of the portion of the targeting structure, which allow a geometrical shape model to be fitted to the cloud such as to describe the surface of the object in a geometrically complete manner. To limit the number of points for fitting the geometrical shape, the computer device 1000 may include or be in electrical communication with a database of reference shapes that have been trained externally.

The method 900 continues at 925 by analyzing the reflected, scattered, or both light from the target area to make one or more measurements of the surface. In examples, the computer system 215 may comprise a 3D geometry reconstruction unit for determining the three-dimensional outer shape of the object(s) being scanned, based on data provided by three-dimensional scanner data. The computer system 215 may further be configured to fit a shape model of the object(s) being scanned to a point cloud to obtain a surface model of an exterior surface of the object(s). The point cloud is used to compute a complete or partially complete outer surface of the object(s) by fitting a shape model of the object(s). Shape models may comprise any technical methods to describe the three-dimensional shape the object(s). The shape model may be based on a computer-aided design (CAD). The method 900 can end at 930.

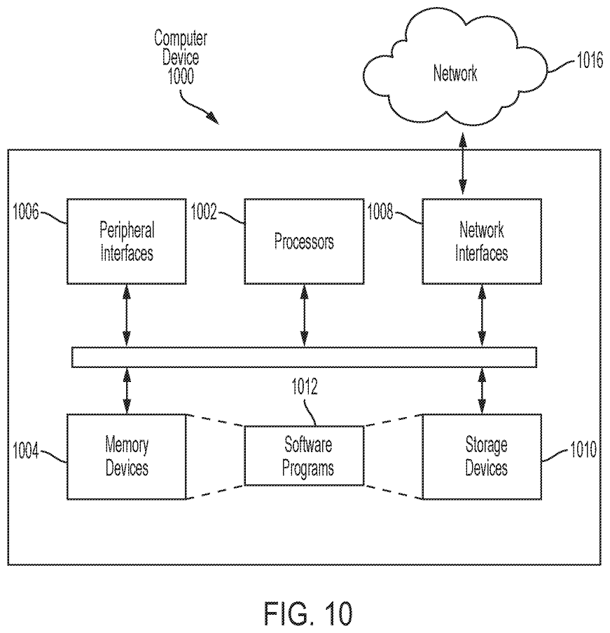

FIG. 10 is an example of a hardware configuration for a computer device 1000, which can be used to perform one or more of the processes described above and/or to implement the computer system 215 described above. The computer device 1000 can be any type of computer devices, such as desktops, laptops, servers, etc., or mobile devices, such as smart telephones, tablet computers, cellular telephones, personal digital assistants, etc. As illustrated in FIG. 10, the computer device 1000 can include one or more processors 1002 of varying core configurations and clock frequencies. The computer device 1000 can also include one or more memory devices 1004 that serve as a main memory during the operation of the computer device 1000. For example, during operation, a copy of the software that supports the above-described operations can be stored in the one or more memory devices 1004. The computer device 1000 can also include one or more peripheral interfaces 1006, such as keyboards, mice, touchpads, computer screens, touchscreens, etc., for enabling human interaction with and manipulation of the computer device 1000.

The computer device 1000 can also include one or more network interfaces 1008 for communicating via one or more networks, such as Ethernet adapters, wireless transceivers, or serial network components, for communicating over wired or wireless media using protocols. The computer device 1000 can also include one or more storage devices 1010 of varying physical dimensions and storage capacities, such as flash drives, hard drives, random access memory, etc., for storing data, such as images, files, and program instructions for execution by the one or more processors 1002.

Additionally, the computer device 1000 can include one or more software programs 1012 that enable the functionality described above. The one or more software programs 1012 can include instructions that cause the one or more processors 1002 to perform the processes, functions, and operations described herein, for example, with respect to the processes of FIG. 9. Copies of the one or more software programs 1012 can be stored in the one or more memory devices 1004 and/or on in the one or more storage devices 1010. Likewise, the data utilized by one or more software programs 1012 can be stored in the one or more memory devices 1004 and/or on in the one or more storage devices 1010.

In implementations, the computer device 1000 can communicate with other devices via a network 1016. The other devices can be any types of devices as described above. The network 1016 can be any type of network, such as a local area network, a wide-area network, a virtual private network, the Internet, an intranet, an extranet, a public switched telephone network, an infrared network, a wireless network, and any combination thereof. The network 1016 can support communications using any of a variety of commercially-available protocols, such as TCP/IP, UDP, OSI, FTP, UPnP, NFS, CIFS, AppleTalk, and the like. The network 1016 can be, for example, a local area network, a wide-area network, a virtual private network, the Internet, an intranet, an extranet, a public switched telephone network, an infrared network, a wireless network, and any combination thereof.

The computer device 1000 can include a variety of data stores and other memory and storage media as discussed above. These can reside in a variety of locations, such as on a storage medium local to (and/or resident in) one or more of the computers or remote from any or all of the computers across the network. In some implementations, information can reside in a storage-area network (“SAN”) familiar to those skilled in the art. Similarly, any necessary files for performing the functions attributed to the computers, servers, or other network devices may be stored locally and/or remotely, as appropriate.

In implementations, the components of the computer device 1000 as described above need not be enclosed within a single enclosure or even located in close proximity to one another. Those skilled in the art will appreciate that the above-described componentry are examples only, as the computer device 1000 can include any type of hardware componentry, including any necessary accompanying firmware or software, for performing the disclosed implementations. The computer device 1000 can also be implemented in part or in whole by electronic circuit components or processors, such as application-specific integrated circuits (ASICs) or field-programmable gate arrays (FPGAs).

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

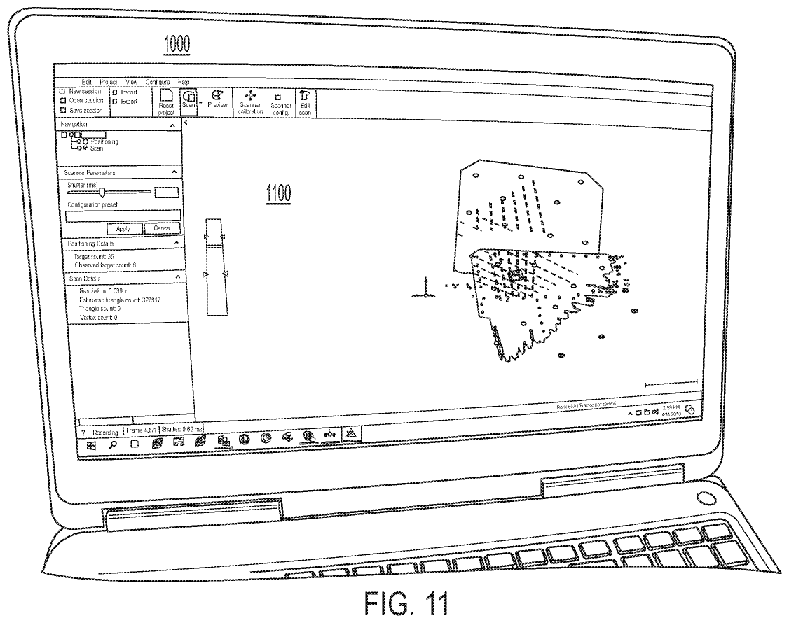

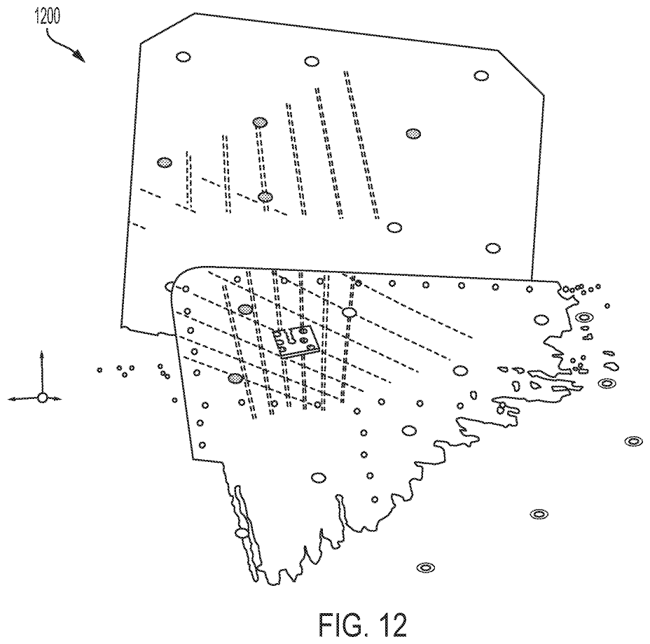

FIG. 11 shows an example of the computer device 1000 running a software program that can process and analyze the data obtained from the 3D scanner 205. The software program can generate data 1100 that can be used by an operator for analysis. FIG. 12 show a close-up of the data 1100 generated by the computer device 1000.

The foregoing description is illustrative, and variations in configuration and implementation can occur to persons skilled in the art. For instance, the various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA), cryptographic co-processor, or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

While the teachings have been described with reference to examples of the implementations thereof, those skilled in the art will be able to make various modifications to the described implementations without departing from the true spirit and scope. The terms and descriptions used herein are set forth by way of illustration only and are not meant as limitations. In particular, although the processes have been described by examples, the stages of the processes can be performed in a different order than illustrated or simultaneously. Furthermore, to the extent that the terms “including”, “includes”, “having”, “has”, “with”, or variants thereof are used in the detailed description, such terms are intended to be inclusive in a manner similar to the term “comprising.” As used herein, the terms “one or more of” and “at least one of” with respect to a listing of items such as, for example, A and B, means A alone, B alone, or A and B. Further, unless specified otherwise, the term “set” should be interpreted as “one or more.” Also, the term “couple” or “couples” is intended to mean either an indirect or direct connection. Thus, if a first device couples to a second device, that connection can be through a direct connection, or through an indirect connection via other devices, components, and connections.

Those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

The foregoing description of the disclosure, along with its associated embodiments, has been presented for purposes of illustration only. It is not exhaustive and does not limit the disclosure to the precise form disclosed. Those skilled in the art will appreciate from the foregoing description that modifications and variations are possible in light of the above teachings or may be acquired from practicing the disclosure. For example, the steps described need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not describe in the embodiments.

Accordingly, the disclosure is not limited to the above-described embodiments, but instead is defined by the appended claims in light of their full scope of equivalents.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or implementations of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B, means A alone, B alone, or A and B. The term “about” indicates that the value listed may be somewhat altered, as long as the alteration does not result in nonconformance of the process or structure to the illustrated implementation. Finally, “exemplary” indicates the description is used as an example, rather than implying that it is an ideal. Other implementations of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A device for providing a targeting platform for a 3D scanning system, the device comprising:
a rigid bulk structure;
a measuring surface arranged on a first side of the rigid bulk structure;
a mounting surface arranged on a second side opposite the first side;
one or more mounting structures arranged on the mounting surface, wherein the one or more mounting structures provides for removable mounting of the device from another surface; and
a plurality of targeting members on the measuring surface,
wherein the measuring surface is arranged to provide supplemental metrology scans for the another surface.

2. The device of claim 1, wherein one or more of the rigid bulk structure, the measuring surface, and the mounting surface comprises a material with a low coefficient of thermal expansion.

3. The device of claim 2, wherein the material comprises carbon fiber, titanium, aluminum, or glass.

4. The device of claim 1, wherein the one or more mounting structures comprise a suction-based mechanism, an adhesive-based mechanism, a magnetic-based mechanism, or combinations thereof.

5. The device of claim 1, wherein the plurality of targeting members are fixed or movable on the measuring surface.

6. The device of claim 1, wherein the plurality of targeting members comprise a material that is contrast-based or retro-reflector based.

7. The device of claim 1, wherein the rigid bulk structure, the measuring surface, the mounting surface is composed of a similar material to the another surface.

8. The device of claim 1, wherein the device further comprises a hinge to permit another device to be flexibly attached.

9. The device of claim 1, wherein the plurality of targeting members are arranged in an asymmetric pattern.

10. The device of claim 1, wherein the plurality of targeting members are arranged having a predetermined density based on characteristics of a 3D scanner.

11. The device of claim 1, wherein the measuring surface, the mounting surface, or both comprises one or more mounting members for attaching one or more scanning aids to provide additional depth to the targeting platform.

12. The device of claim 11, wherein the one or more scanning aids comprise a prism or a tooling ball.

13. The device of claim 11, wherein the one or more mounting members comprise one or more holes.

14. The device of claim 12, wherein the tooling ball comprises a scale bar to provide for validation of a scale of at least a portion of the measuring surface.

15. A 3D scanning system comprising:
a 3D scanner;
a device for providing a targeting platform, the device comprising:
a rigid bulk structure;
a measuring surface arranged on a first side of the rigid bulk structure;
a mounting surface arranged on a second side opposite the first side;
one or more mounting structures arranged on the mounting surface, wherein the one or more mounting structures provides for removable mounting of the device from another surface; and
a plurality of targeting members on the measuring surface,
wherein the measuring surface is arranged to provide supplemental metrology scans for the another surface,
a computer comprising at least one hardware processor configured analyze data received from the 3D scanner.

16. The 3D scanning system of claim 15, wherein one or more of the rigid bulk structure, the measuring surface, the mounting surface comprises a material with a low coefficient of thermal expansion.

17. The 3D scanning system of claim 16, wherein the material comprises carbon fiber, titanium, aluminum, or glass.

18. The 3D scanning system of claim 15, wherein the one or more mounting structures comprise a suction-based mechanism, an adhesive-based mechanism, a magnetic-based mechanism, or combinations thereof.

19. A method for 3D scanning comprising:
attaching a targeting structure to a surface to be scanned, wherein the targeting structure comprises:
a measuring surface arranged on a first side of a rigid bulk structure;
a mounting surface arranged on a second side opposite the first side;
one or more mounting structures arranged on the mounting surface, wherein the one or more mounting structures provides for removable mounting of the targeting structure from another surface; and
a plurality of targeting members on the measuring surface,
wherein the measuring surface is arranged to provide supplemental metrology scans for the another surface;
scanning a target area of the surface and a portion of the targeting structure with an optical scanner;
detecting reflected, scattered, or both light from the target area; and
analyzing the reflected, scattered, or both light from the target area to make one or more measurements of the surface.
